(19) United States
(12) Patent Application Publication
(10) Pub. No.: US 2007/0145262 A1
(43) Pub. Date: Jun. 28, 2007

(54) On-chip electrochemical flow cell

(76) Inventors: Yu-Chong Tai, Pasadena, CA (US); Jun Xie, Foster City, CA (US); Darron K. Young, San Gabriel, CA (US)

Correspondence Address: CHRISTIE, PARKER & HALE, LLP, PO BOX 7068, PASADENA, CA, 91109-7068, US

(21) Appl. No.: 11/454,364

(22) Filed: Jun. 16, 2006

Related U.S. Application Data
(60) Provisional application No. 60/691,534, filed on Jun. 17, 2005.

(51) Int. Cl. H01J 49/00

(52) U.S. Cl. 250/288

(57) ABSTRACT

A microfluidic device including at least one microfabricated electrochemical flow cell and method of manufacturing such a device are disclosed herein. The electrochemical cell comprising at least a substrate, wherein the substrate has a front face and a back face; a channel wall bonded to the front face of the substrate without using a spacer, wherein the wall and the substrate define a microchannel having an inlet for receiving a fluid and an outlet for transmitting the fluid; a plurality of electrodes inside the microchannel, wherein said plurality of electrodes comprises one or more working electrodes and one or more counter electrodes, wherein the fluid flows over the surface of the plurality of electrodes and wherein optionally a length of the microchannel over the one or more working electrodes is greater than a height of the microchannel over the one or more working electrodes. Other peripherals may also be included in the microfluidic device of the current invention, including an electrospray ionization (ESI) nozzle, one or more detectors, a chromatographic column, etc. each of which may be microfluidically coupled to the electrochemical flow cells to create more complicated analytic devices.

### CROSS-REFERENCE TO RELATED APPLICATIONS

This application claims priority based on U.S. provisional application No. 60/691,534, filed Jun. 17, 2005, the disclosure of which is incorporated herein by reference.

### STATEMENT REGARDING FEDERALLY SPONSORED RESEARCH

The U.S. Government has certain rights in this invention pursuant to grant No. 5R01 RR06217-10, awarded by the National Institutes of Health.

### FIELD OF THE INVENTION

The present invention relates generally to the field of microfluidics and in some applications nanofluidics, and in particular, to a microfabricated electrochemical flow cell and an electrochemical flow cell integrated with electrospray ionization (ESI) nozzle and methods of making and methods of using these cells.

### BACKGROUND OF THE INVENTION

Electrochemical flow cells are well known for use as detectors for a variety of separation techniques such as liquid chromatography and capillary electrophoresis. For example, the use of electrochemical flow cells in liquid chromatography is disclosed in U.S. Pat. Nos. 4,413,505 and 4,552,013 to Matson, both incorporated hereby by reference in their entirety.

Elements of an electrochemical flow cell generally include a channel, through which a fluid containing an analyte flows, a working electrode, which is exposed to the fluid and where the electrolysis of the analyte occurs, and a counter electrode, which forms an electrical circuit with the working electrode. Many electrochemical flow cells also include a reference electrode that allows to control a potential on the working electrode.

One typical application of electrochemical cells is to improve the function of electrospray ionization sources. A conventional electrospray ionization (ESI) source is a device that operates electrolytically in a fashion generally analogous to a two electrode electrochemical flow cell, where a metal capillary or other conductive contact placed near the point, from which a charged electrospray droplet plume is generated, acts as the working electrode in the ESI source.

One issue with conventional electrospray sources is that the compounds most amenable to ionization through the electrospray process are ionic compounds. To improve the ionization of neutral and non-polar compounds, the electrochemical ionization source can be coupled to an electrochemical flow cell. Coupling of electrochemical flow cell with electrospray ionization nozzle is disclosed, for example, by Zhou and Van Berkel, “Electrochemistry Combined On-Line with Electrospray Mass Spectrometry”, Anal. Chem., 1995, 67, 3643-3649; U.S. Pat. No. 5,879,949 to Cole and Xu; U.S. Pat. No. 6,784,439 to Van Berkel; and US Patent Publication No. 2004/0245457 to Granger and Van Berkel, the disclosures of which are also incorporated herein by reference.

Analytical techniques utilizing electrochemical flow cells and electrospray ionization sources are important for a number of applications including the growing field of proteomics. One of the demands of the proteomic research, for example, is the miniaturization of bioanalytical techniques, see e.g., T. Laurell and G. Marko-Varga, “Miniaturization is mandatory unraveling the human proteome”, Proteomics, 2002, 2, pp. 345-351; and Lion, N. et al., Electrophoresis, 2003, 24, 3533-3562, both of which are incorporated hereby by reference in their entirety. The miniaturization of bioanalytical techniques includes the miniaturization of the components of bioanalytical systems such as electrochemical flow cells and electrospray ionization sources. Accordingly, a need exists for better integrated, more versatile, and generally smaller systems, which can be conveniently fabricated and used in for example disposable applications.

### SUMMARY OF THE INVENTION

The present invention is directed generally to a microfabricated electrochemical flow cell and an electrochemical flow cell integrated with electrospray ionization (ESI) nozzle and methods of making and methods of using these cells.

In one embodiment of the invention the microfabricated electrochemical flow cell comprises a substrate, a channel wall bonded to the front face of the substrate without using a spacer, wherein the wall and the substrate define a microchannel having one or more inlets and one or more outlets for receiving a fluid and for transmitting the fluid; a plurality of electrodes inside the microchannel, wherein said plurality of electrodes comprises one or more working electrodes and one or more counter electrodes, wherein the fluid flows over the surface of the plurality of electrodes.

In another embodiment, the length of the microchannel over the one or more working electrodes is greater than the height of the microchannel over the one or more working electrodes.

In still another embodiment, an integrated structure is formed, wherein the channel wall is directly bonded to the front face of the substrate.

In yet another embodiment, the microchannel may also have one or more outlets.

In still yet another embodiment of the invention the microfluidic device comprises an electrochemical flow cell integrated with an electrospray ionization (ESI) nozzle on the front face of the substrate. In such an embodiment, the electrochemical flow cell may be microfluidically coupled to the ESI nozzle.

In still yet another embodiment of the invention the microfluidic device comprises one or more electrochemical flow cells on the front face of the substrate, and an electrospray ionization (ESI) nozzle on the front face the substrate, wherein the electrospray ionization nozzle is microfluidically coupled to at least one of the electrochemical flow cells.

In one embodiment, the invention is directed to a process of making a microfluidic device integrating an electrochemical flow cell and, if desired, an ESI nozzle.

In one such embodiment, the process includes the steps of: providing a substrate; microfabricating a microchannel on the substrate without use of a spacer and a plurality of electrodes inside the microchannel, including one or more working electrodes, wherein a length of the microchannel over the one or more working electrodes is greater than a height of the microchannel over the one or more working electrodes. In such a processing method an electrospray ionization nozzle can be microfabricated to be integral with the microchannel.

In another such embodiment, process includes integrating an electrochemical flow cell and an electrospray ionization nozzle comprising providing a substrate having a front surface and a back surface; patterning a plurality of electrodes on the front surface; depositing and patterning a first polymer layer on the front surface of the substrate to define a floor of the nozzle; depositing and patterning a sacrificial photoresist layer over the front surface of the substrate, the plurality of the electrodes and the first polymer layer to define a microchannel region; depositing and patterning a second polymer layer over the sacrificial photoresist layer to define a channel wall; releasing the sacrificial photoresist to define a microchannel,

### BRIEF DESCRIPTION OF THE DRAWINGS

These and other features and advantages of the present invention will be better understood by reference to the following detailed description when considered in conjunction with the accompanying drawing wherein:

FIG. 1 illustrates a first embodiment of a microfabricated flow cell in accordance with the current invention;

FIG. 2 illustrates a second embodiment of a microfabricated flow cell in accordance with the current invention;

FIG. 3 illustrates an embodiment of a microfabricated flow cell in accordance with the current invention including an interdigitated electrode design wherein working electrodes alternate with counter electrodes;

FIG. 4 illustrates an embodiment of a microfabricated flow cell in accordance with the current invention including a working electrode comprising packed conductive particles;

FIG. 5 illustrates an embodiment of a microfabricated flow cell in accordance with the current invention including an integrated electrospray ionization nozzle;

FIG. 6 illustrates an embodiment of a microfabricated flow cell in accordance with the current invention including electrochemical flow/detection cells on the same substrate with an electrospray ionization nozzle;

FIG. 7 illustrates an exemplary process flow for fabrication of electrochemical flow cell/electrospray ionization nozzle in accordance with the current invention; and

FIG. 8 illustrates an embodiment of a fabricated electrochemical flow cell integrated with electrospray ionization nozzle in accordance with the current invention.

### DETAILED DESCRIPTION OF THE PREFERRED EMBODIMENTS

The present invention relates generally to the field of microfluidics and nanofluidics. In particular, the present invention is directed to a microfabricated electrochemical cell and an electrochemical cell integrated with electrospray ionization (ESI) nozzle and methods of making and using these cells.

The following references can be useful for understanding and practicing this invention, the disclosures of each of these references are incorporated herein by reference in their entirety. It should be understood that the inclusion of these references herein is not intended to be an admission that they are to be considered prior art for patentability purposes. US Patent Publication No. 2005/0051489 “IC-processed Polymer Nano-liquid Chromatography System” by Tai et. al.; US Patent Publication No. 2003/0228411 “A Method for Integrating Micro- and Nanoparticles Into MEMS and Apparatus Including the Same” by Tai et. al.; U.S. patent application Ser. No. 09/442,843, “Polymer Based Electrospray Nozzle for Mass Spectrometry” by Tai et. al, filed Nov. 18, 1999; US Patent Publication No. 2004/0124085 “Microfluidic Devices and Methods with Electrochemically Actuated Sample Processing” by Tai et. al.; US Patent Publication No. 2004/0237657 “Integrated Capacitive Microfluidic Sensors Method and Apparatus” by Tai et. al.; US Patent Publication No. 2004/0188648 “Integrated Surface-Machined Micro Flow Controller Method And Apparatus” to Xie et. al.; U.S. patent application Ser. No. 11/059,625, “On-Chip Temperature Controlled Liquid Chromatography Methods and Devices” by Tai et, al., filed Feb. 17, 2005; U.S. Pat. No. 6,436,229 “Gas phase silicon etching with bromine trifluoride” to Tai et. al.; U.S. Pat. No. 6,162,367 “Gas phase silicon etching with bromine trifluoride” to Tai et. al.; U.S. Provisional Patent Application No. 60/663,181, “Wafer Scale Solid Phase Packing” filed Mar. 18, 2005; U.S. patent application Ser. No. 11/404,496, “Integrated Chromatography Devices and Systems for Monitoring Analytes in Real Time and Methods for Manufacturing the Same” filed Apr. 14, 2006; and U.S. Provisional Patent Application No. 60/592,588, “Modular Microfluidic Packaging System” by Tai et. al., filed Jul. 28, 2004. Whether listed here or not, all of the publications, patent applications and patents cited in this specification are incorporated herein by reference in their entirety.

In general terms the current invention is directed to a microfluidic device including one or more microfabricated electrochemical flow cells, either alone or in combination with an electrospray ionization source or other peripheral devices.

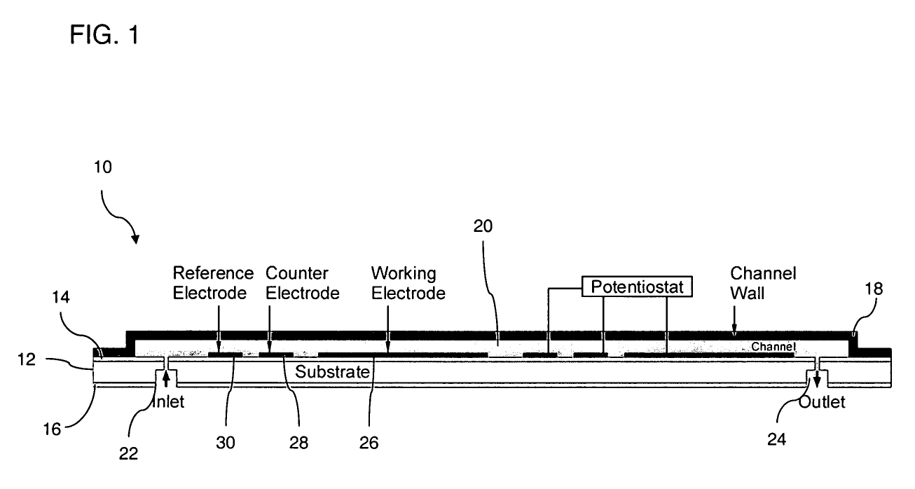

As shown in FIG. 1, in one embodiment the microfluidic device of the current invention is a microfabricated electrochemical flow cell (10) comprising a substrate (12), having a front face (14) and a back face (16). Bonded to the front face of the substrate is a channel wall (18) that defines a microchannel (20). One important feature of the microfluidic device of the current invention is that the microchannel is formed without using a spacer, or alternatively called a gasket. The device has at least one inlet (22) for receiving a fluid containing one or more analytes and at least one outlet (24) for transmitting the fluid from the microchannel. Within the fluidic device are disposed a plurality of electrodes inside the microchannel, wherein the plurality of electrodes includes at least one working electrodes (26) and one or more counter electrodes (28) such that the fluid flows over the surface of the plurality of electrodes and wherein a length of the microchannel over the one or more working electrodes is greater than the height of the microchannel. Optionally, the plurality of electrodes can further comprise one or more reference electrodes (30) so that three electrode electrochemical measurements can be carried out.

Turning now to the specific structure of the device, the substrate can be made from any suitable material, such as, for example, a semiconductor substrate such as silicon. Alternatively, the substrate can be made of glass or plastic such as polyimide, parylene, polycarbonate, etc. Likewise, the channel wall can be made of any suitable structural material, such as, for example, a polymer material such as parylene or polyimide. In the preferred embodiment, parylene is used as a structural material for the channel wall and photoresist can be used as a sacrificial layer to define the microchannel. The microchannel can be made, for example, by methods similar to methods of making microfluidic channels using a sacrificial layer of photoresist disclosed in, for example, U.S. Patent Publication No 2004/023657 to Xie et. al.; and in U.S. Patent Publication No. 2005/0051489 to Tai et. al., both of which are incorporated herein by reference in their entirety.

Although any suitable electrode may be incorporated into the microfluidic device of the current invention, preferably, the electrodes is flat or substantially flat. In one exemplary embodiment, the electrodes are thin film electrodes comprising a metal such as Ti, Au, Pt, Pd, Cr, Cu or Ag, or an alloy or combination thereof. Suitable thin film metal electrodes can be made, for example, by methods similar to those described in US Patent Publication No. 2005/005 1489 to Tai et. al., which is incorporated herein by reference in its entirety. Although only metal electrodes have been discussed thus far, the electrodes can be also be made of thin film carbon, graphite; pyrolyzed carbon or a combination thereof. Suitable pyrolyzed carbon electrodes can be made, for example, by methods similar to those described in U.S. patent application Ser. No. 10/973,938, filed Oct. 25, 2004, or U.S. patent application Ser. No. 11/040,116, filed Jan. 24, 2005, both of which are incorporated herein by reference in their entirety. It should be understood that although all of the electrodes in a device could be formed of the same material, each of the different electrodes can also utilize a different electrode material. In addition, the electrode height or thickness can also be varied, such as, for example, up to about one micron, or up to about 500 nm, or for example about 100 nm to about 500 nm or about 100 nm to about 300 nm.

Finally, although the above discussion has focused on single cell device, as shown in FIG. 1, in some embodiments, the microfabricated electrochemical flow cell can comprise an array of electrochemical cells (A & B)), wherein each of the electrochemical cells can be defined by one of the working electrodes and one of the counter electrodes. Each of the electrochemical cells can further comprise a reference electrode. The electrochemical cells in the array can be placed in any suitable geometry, such as in series as illustrated, for example, on FIG. 1.

Although the basic structures of the device have been shown in FIG. 1, and described above, it should be understood that the device may also include other conventional peripheral structures. For example, in some embodiments, the microfluidic device can further comprise external reference electrodes (not shown), which can be used together with the microfabricated electrodes inside of the microchannel. The external reference electrode can be, for example, Ag/AgCl or any other appropriate reference electrode. Further, in some embodiments, the microfabricated flow cell can optionally further comprise one or more electrical sources, each coupled to at least one of the working electrodes and to at least one of the counter electrodes. The electrical source can be also coupled to one of the reference electrodes for embodiments of the flow cell comprising the reference electrodes.

Although there has been no discussion of the dimensions or geometry of the microfluidic device of the current invention thus far, using microfabrication technology allows for the volume of the microchannel to be made very small. For example, the volume of the channel can be from about 0.1 nL to about 200 nL, and more preferably from about 1 nL to about 100 nL. The small volume of the microchannel can be extremely advantageous and important for applications that operate under small flow rates, e.g., from 10 nL/min to 10 μL/mm. Examples of these applications include analytical applications such as capillary or nanoliquid chromatography or nano capillary electrophoresis, and ion mobility spectroscopy. Additionally, other examples of the applications can be diagnostic applications for bodily fluid (e.g., blood, urine, saliva or serum) analysis. Also, the combination of exquisite control of small volumes and chemical modification of fluid can be utilized for drug delivery, or spot filling for MALDI preparation, and other mass spectral methods. Due to its small form factor and integratable platform, this microfabrication technology can be utilized for portable field devices, or anytime when the size of the total device needs to be small.

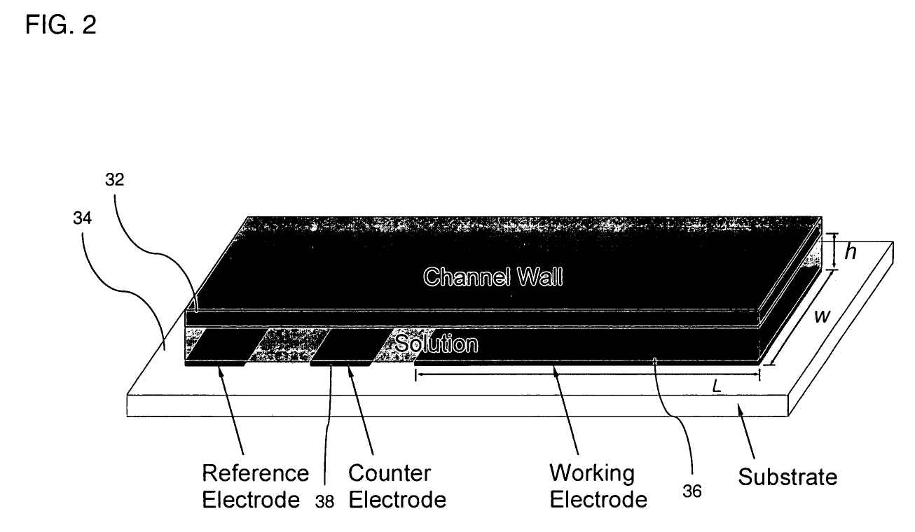

In addition, although the above discussion has focused on the general design parameters of the microfluidic device of the current invention, specific design geometries can greatly improve the electrochemical reaction efficiency within the cell. In one embodiment, shown schematically in FIG. 2, the plurality of electrodes can be deposited at the bottom of the microchannel (32), i.e., on the front face of the substrate (34). In such an embodiment, each of the plurality of electrodes can be extended to the full width of the microchannel defined as a distance perpendicular to the flow of the fluid containing the analyte and parallel to the front face of the substrate. As a result, the working electrode (36) has a larger area exposed to the fluid containing the analyte than the counter electrode (38), as illustrated in FIG. 2. In such an embodiment, the height of the microchannel over the working electrodes can range from about 0.1 micron to about 100 microns, preferably from about 1 micron to about 25 microns, most preferably from about 1 micron to about 10 microns. Microfluidic channels having such heights and methods of making them are described, for example, in US Patent Publication No. 2005/005 1489 to Tai et, al.; and US Patent Publication No. 2004/0237657 to Xie et. al., both of which are incorporated herein by reference in their entirety. In the above and following discussion the length of the microchannel over the working electrodes can be defined as the distance in the direction of the flow of the fluid over the working electrodes, and the height of the microchannel over the working electrodes can be defined as the distance between the front surface of the working electrodes and the channel wall perpendicular to the front surface of the substrate. Although not specified above, the length of the microchannel over the working electrodes can be greater than the height of the microchannel over the working electrodes. The length and the width of the microchannel over the working electrodes can be, for example, at least 10 times greater than the height of the microchannel over the working electrodes, more preferably at least 100 times greater, most preferably 1000 times greater than the height of the microchannel over the working electrodes. This geometry allows the analyte to diffuse through the height of the microchannel channel to the working electrode while the analyte is in the cell, thus, increasing the efficiency of the electrochemical flow cell. For example, using these specific design parameters can convert a normal amperometric/potentiometric electrochemical cell (typically <10% efficiency) into a coulometric electrochemical cell (typically >90% efficiency). For example, efficiencies of such cells can be at least 50%, preferably at least 80%, and even more preferably or at least 90%.

The efficiency of such cells can be estimated using general modeling analysis. For example, the following calculation illustrates the advantages of the improved geometries of the electrochemical cell. It should be understood that the particular numbers used in this calculation are used only for illustration and are not meant to limit this invention. General modeling analysis uses the height, length, and width of the microchannel with respect to the fluid flow over the working electrode. The flow inside microfluidic channels over the working electrode such as the microchannel is generally laminar. The time for the analyte at the top of the microchannel to diffuse through the height of the channel to the working electrode can be estimated approximately as shown in Equation 1:

$${t}_{1} = \frac{{h}^{2}}{D} \qquad ( 1 )$$

assuming a linear concentration gradient; where D is the diffusion constant and h is the height of the microchannel over the working electrode. Likewise, the time for the fluid containing the analyte to flow through the microchannel can estimated according to Equation 2:

$${t}_{2} = \frac{whL}{Q} \qquad ( 2 )$$

where Q is the flow rate, and L and w are the length and the width of the microchannel with respect to the working electrode.

To achieve high efficiencies in the electrochemical flow cell, it is necessary for t₁, the time for the analyte to reach the working electrode, to be smaller than t₂, the time for the fluid containing the analyte to flow through the length of the microchannel over the working electrode region. Thus, it is preferable for the dimensions of the cell to follow the equality given in Equation 3, below.

$$Lw > \frac{hQ}{D} \qquad ( 3 )$$

For example, when h=5 μm, D=10⁻¹⁰ m²/s, Q=1.2 μL/min, and w=500 μm, then the length of the microchannel L can be greater than 2 mm.

As shown above, the width of the microchannel w with respect to the working electrode can also play an important role in the increasing the efficiency of the electrochemical flow cell. Accordingly, in one preferred embodiment of the present invention, the width of the microchannel with respect to the working electrode is greater than the height of the microchannel over the working electrode. For example, in one preferred embodiment, the width of the microchannel with respect to the working electrode can be 10 times greater than the height of the microchannel over the working electrode, more preferably 100 times greater than the height of the microchannel, and most preferably 1000 times than the height of the microchannel over the working electrode.

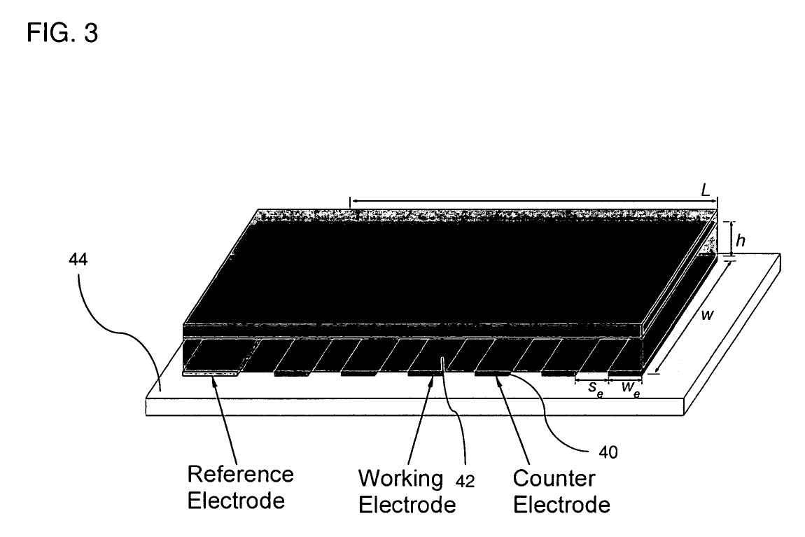

Although the above embodiments have focused on the overall dimensions of the electrodes and channel of the microfluidic device of the current invention, it should also be understood that alterations in the shape and alignment of these elements can also be used to tailor the performance of the device. For example, in one embodiment of the microfabricated electrochemical flow cell of the current invention, as shown in FIG. 3, the counter electrodes (40) and the working (42) electrodes can be disposed on the substrate (44) as interdigitated electrodes. The width of each counter electrode can be the same as the width of each working electrode (designated as wₑ on FIG. 3). The width of the electrodes wₑ in this design can be from about 10 nm to about 100 μm, and preferably from 1 μm to 100 μm. The interdigitated electrodes can be placed equidistantly or may be varied. The spacing sₑ between two neighboring electrodes can defined as a shortest distance between the edges of the adjacent electrodes and can be equal to the width wₑ of the electrodes. In the interdigitated design, the spacing between the electrodes can be from about 10 nm to about 100 μm, and preferably from 1 μm to 100 μm

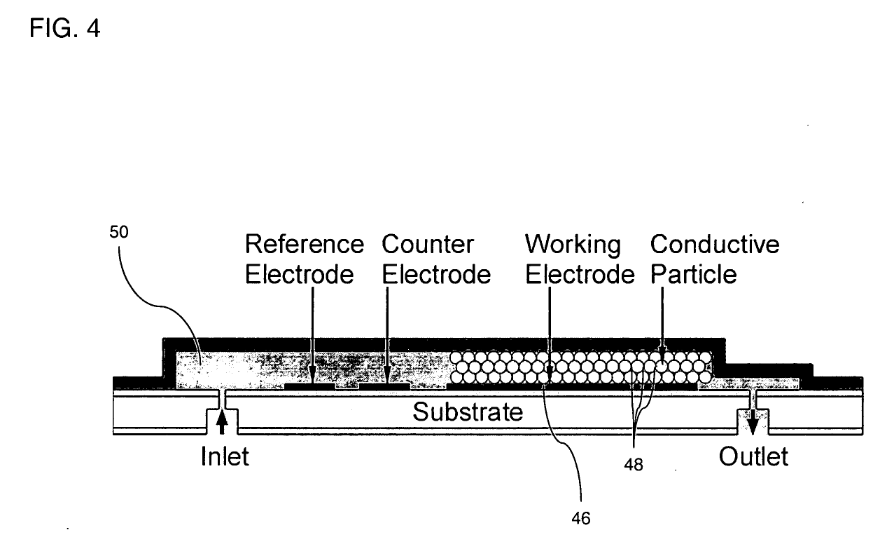

In some embodiments of the microfabricated cell of the current invention, as shown in FIG. 4, one of the working electrodes (46) can comprise a plurality of conductive particles (48) packed inside the microchannel (50). Any suitable conductive microparticle or nanoparticle may be used with such an embodiment. For example, the conductive particles can be, for example, metal particles, porous graphite or porous carbon. Using conductive particles as a part of the working electrode substantially increases the contact area between the working electrode and the solution flowing through the microchannel and, thus, reduces the time necessary for the analyte in the solution to diffuse towards the working electrode thereby increasing the efficiency of the electrochemical flow cell. As such, the use of the conductive particles can allow for the length of the working electrode to be reduced. Packing of the conductive particles inside the microchannel can be carried out, for example, using methods for packing microparticles described in US Patent Publication No. 2003/0228411 to Tai et al.; and in U.S. Provisional Patent Application No. 60/663,181, “Wafer Scale Solid Phase Packing” filed Mar. 18, 2005, the disclosures of both of which are incorporated herein by reference in their entirety.

Although thus far only microfluidic device comprising simple electrochemical flow cells have been described, in some embodiments, the microfabricated electrochemical flow cell can further comprise additional sensor or analytical tools.

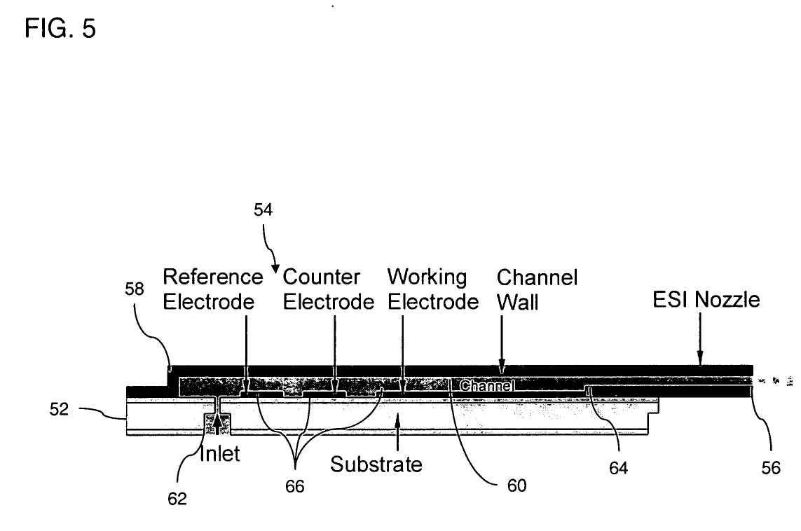

For example, in one embodiment of the invention, as shown in FIG. 5, the microfluidic device comprises a substrate (52) and an electrochemical flow cell (54) integrated with an electrospray ionization nozzle (56). In such an embodiment, the electrospray nozzle can be the ESI nozzle described in the U.S. patent application Ser. No. 09/442,843, “Polymer Based Electrospray Nozzle for Mass Spectrometry” to Desai et. al, filed Nov. 18, 1999, the disclosure of which is incorporated herein by reference in its entirety. Such an embodiment shares many features in common with the standard electrochemical cell. For example, the electrochemical flow cell can comprise a channel wall (58) on a front surface of the substrate, wherein the wall and the substrate define a microchanncl (60) having an inlet (62) for receiving a fluid containing one or more analytes and an outlet (64) for transmitting the fluid from the channel. However, in this embodiment the outlet forms an outlet of and ESI nozzle, and the plurality of electrodes (66, e.g., one or more working electrodes, one or more counter electrodes, and optionally one or more reference electrodes) can be used singly or together to apply the high voltage necessary for the electrospray ionization process.

The electrochemical flow cell integrated with the ESI nozzle can be substantially similar to or the same as the microfabricated electrochemical flow cell of the earlier embodiment. For example, the ESI electrodes can be made of thin-film metal such as Ti, Au, Pt, Pd, Cr, Cu, Ag; carbon, graphite; pyrolyzed carbon or a combination thereof. The channel wall can, for example, comprise a polymer material such as parylene or polyimide. The substrate can be a semiconductor substrate such as silicon, or alternatively glass, plastic, or polymer material. An as before, in a preferred embodiment, parylene can be used as a structural material for the channel wall and a photoresist can be used as sacrificial layer to define the channel.

The geometry of the electrochemical cell integrated with the ESI nozzle can also be substantially similar to or the same as the geometry of the microfabricated electrochemical flow cell of the earlier embodiment. For example, each of the plurality of electrodes can be extended to the full width of the microchannel (defined as a distance perpendicular to the flow of the fluid containing the analyte and parallel to the front face of the substrate). The working electrode can have a larger area exposed to the fluid containing the analyte than the counter electrode. The working electrode can cover substantial area on the substrate inside the microchannel. The height of the microchannel can range from about 0.1 micron to about 100 microns, preferably from about 0.1 micron to about 25 microns, and most preferably from about 1 micron to about 10 microns. Preferably, the length of the microchannel is greater than the height of the microchannel. The length and the width of the microchannel each can be, for example, at least 10 times greater than the height of the microchannel, more preferably at least 100 times greater, most preferably 1000 times greater than the height of the microchannel.

Also as in the previous embodiments, microfabrication technology and the integration of the electrochemical flow cell with the ESI nozzle can allow for the minimization of the dead and swept volume of the microfluidic device. For example, the total volume of the microchannel in the microfluidic device can be, for example, from about 0.1 nL to about 100 nL. The small volume of the microchannel can be extremely important for the analytical applications operating under small flow rates (10 nL/min to 10 μL/min), such as capillary, nano liquid chromatography, or nano capillary electrophoresis. Although specific volumes are discussed, it should be understood that using these microfabrication techniques, the total volume can be optimized to control the time needed for chemical modification of a specific reaction, while not allowing other reactions to occur.

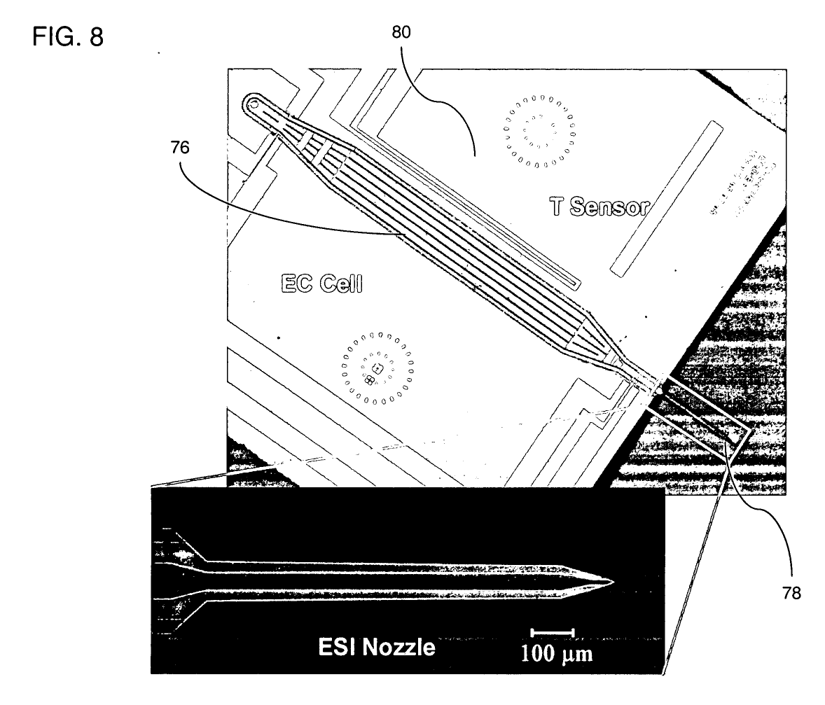

Although the above discussion has focused on embodiments of microfluidic devices wherein an ESI is integrated with the electrochemical flow cell, it should be understood that the present invention is not limited to such devices. For example, in one embodiment of the invention the microfluidic device can includes a electrochemical flow cell having a sensor, such as a resistive temperature detector (RTD, see, e.g., FIG. 8) integrated on the front surface of the substrate. In such an embodiment, any suitable sensor or RTD can be used in such an embodiment, such as, for example, a thin film metal resistor.

Likewise, in some embodiments, a chromatography column can be microfabricated on the front surface of the substrate. The microfabricated chromatography column can be similar to, for example, a chromatography column disclosed in US Patent Publication No. 2005/0051489, the disclosure of which is incorporated herein by reference. The microfabricated chromatography column can be placed in series with the microfabricated flow cell, i.e., the outlet of the column can be microfluidically coupled to the inlet of the flow cell such that the microfabricated column provides an eluent that can serve as the fluid containing one or more analytes to the microfabricated flow cell.

Additionally, different combinations of these optional devices may be combined in a single microfluidic device. For example, in some embodiments, the microfluidic device can comprise a chromatography column and an ESI and/or RTD. In such an embodiment the outlet of the microfabricated column can be microfluidically coupled to the inlet of the electrochemical flow cell as discussed above, a resistive temperature detector (RTD) can be integrated on the front surface of the substrate, and an ESI can be integrated into the outlet of the electrochemical flow cell.

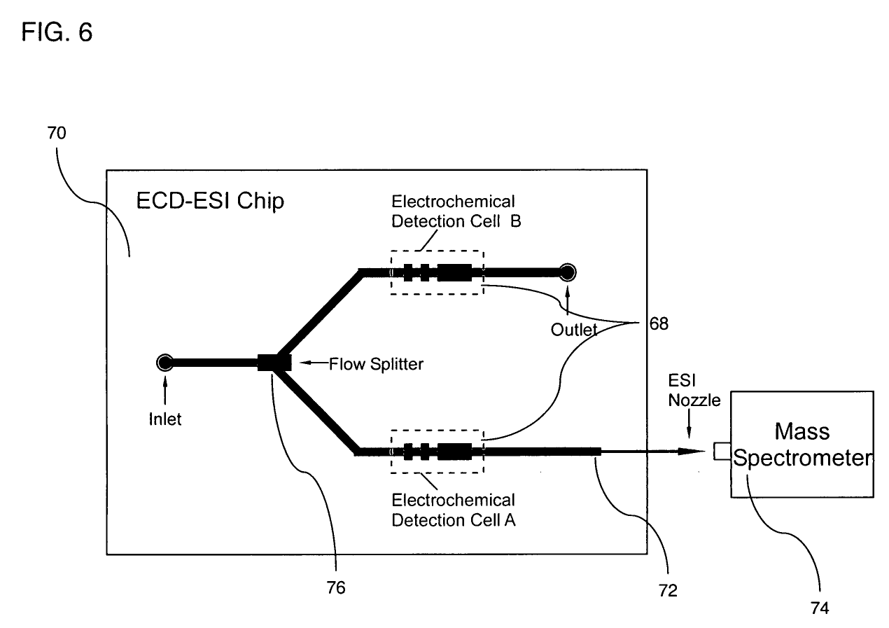

In addition to microfluidic devices that include multiple peripheral devices attached to a single electrochemical cell, the present invention is also directed to a device comprising one or more electrochemical flow cells. One embodiment of such a microfluidic device is shown in FIG. 6. In this embodiment, a plurality of electrochemical flow cells (68) are disposed on a substrate (70), and an electrospray ionization nozzle (72), wherein the electrospray ionization nozzle is microfluidically coupled to at least one of the electrochemical flow cells. The outlet of the ESI nozzle can then be directed to another analytic device, such as, for example a mass spectrometer (74). The electrospray ionization nozzle can be, for example, the electrospray ionization nozzle integrated with electrochemical flow cell as described above. Each of the electrochemical flow cells can be, for example, similar to the microfabricated electrochemical flow cell described above.

In such an embodiment, the plurality of electrochemical flow cells may be arranged in any suitable way. For example, in some embodiments at least one of the electrochemical flow cells can be in series with the ESI nozzle. When the electrochemical flow cell is in series with the ESI nozzle, a fluid containing the analyte can be first analyzed by the electrochemical flow cell and subsequently by the ESI mass spectrometry. Alternatively, as shown in FIG. 6, at least one of the electrochemical flow cells can be in parallel with ESI nozzle, and one of the electrochemical flow cells can be in series with the ESI nozzle. For example, on FIG. 6, the electrochemical cell (A) illustrates the electrochemical flow cell in series with the ESI nozzle, while the electrochemical cell (B) illustrates the electrochemical flow cell in parallel with the ESI nozzle. In some embodiments, the microfluidic device can further comprise a flow splitter (76), wherein the flow splitter can split a flow of the fluid containing the analyte between the ESI nozzle and the electrochemical flow cell parallel to the ESI nozzle. In some embodiments, the microfluidic device of such an embodiment can further comprise a microfabricated chromatography column (not shown) placed in series prior to one of the electrochemical flow cells. The microfabricated chromatography column can be similar to, for example, a chromatography column disclosed in US Patent Publication 2005/0051489, the disclosure of which is incorporated herein by reference. Such a microfabricated chromatography column can be microfluidically coupled to one or more of the electrochemical cells directly or through the flow splitter. The microfabricated chromatography column can also provide an eluent that can serve as the analyte containing fluid.

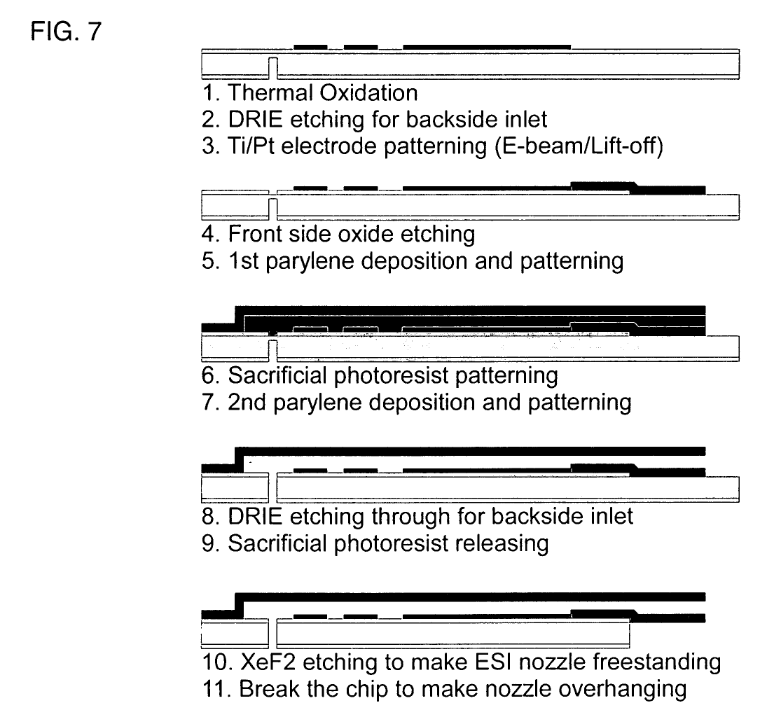

Finally, although only microfluidic devices have been described thus far, the current invention is also directed to methods of fabricating the microfluidic devices described herein. For example, in one embodiment a process uses parylene as structural material and photoresist as sacrificial layer. The fabrication process flow for a microfluidic device integrating electrochemical flow cell and electrospray ionization nozzle on a substrate can be as shown in FIG. 7. In this embodiment, the fabricating process includes one or more of the following steps:
providing a substrate;
microfabricating a microchannel on the substrate without use of a spacer and a plurality of electrodes inside the microchannel, including one or more working electrodes, wherein a length of the microchannel over the one or more working electrodes is greater than a height of the microchannel over the one or more working electrodes.

Furthermore, the process can comprise microfabricating an electrospray ionization nozzle to be integral with the microchannel and substrate. More particularly, the process of making a microfluidic device integrating electrochemical flow cell and ESI nozzle can include one or more of the following:
providing a substrate having a front surface and a back surface and thermally oxidizing the front surface of the substrate (Step 1);
defining an inlet through the back surface of the substrate by, for example, deep ion reactive etching (DRIE) or other appropriate technique (Step 2);
depositing and patterning a plurality of thin film electrodes using, for example, a combination of E-beam lithography and thermal lift-off (Step 3);
etching the oxide on the front surface of the substrate (Step 4);
depositing and patterning a first layer of a polymer material such as parylene or polyimide and then depositing and patterning a layer of a sacrificial material such as photoresist to define a microchannel region (Step 5);
depositing a second layer of a polymer material to define a microchannel wall (Step 6);
finishing the inlet through the back surface of the substrate by, for example, DRIE or other appropriate technique (Step 7);
releasing the sacrificial material to define a microchannel (Step 8); and
making the ESI nozzle free standing by, for example XeF₂ or BrF etching (Step 9); and
breaking up the substrate to make the nozzle overhanging (Step 10).

FIG. 8 provides a photographic picture of a microfluidic device having an electrochemical cell (76) and an integrated ESI nozzle (78) fabricated on a single substrate (80) in accordance with the methods described above. As previously discussed, the advantages of using microfabrication techniques for making electrochemical flow cells and microfluidic devices of the present invention can be, for example, low cost for mass production, ease to operate and minimizing the amount of fluidic connections.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

What is claimed is:

1. A microfabricated electrochemical flow cell comprising
a substrate having a channel wall bonded thereto, wherein the wall and the substrate define a microchannel having a length and a height, said microchannel being formed without a spacer;
at least one inlet and at least one outlet formed in said microchannel for receiving and transmitting a fluid;
a plurality of electrodes formed within the space defined by the microchannel, wherein said plurality of electrodes include at least one working electrode and at least one counter electrode; and
wherein the electrodes are disposed within said microchannel such that fluid flowing within the microchannel contacts the surface of the plurality of electrodes, and wherein the length of the microchannel over the working electrodes is greater than the height of the microchannel over the working electrodes.

2. The flow cell of claim 1, wherein the substrate is formed of a material selected from the group consisting of silicon, glass and plastic.

3. The flow cell of claim 1, wherein the channel wall comprises a polymer material.

4. The flow cell of claim 3, wherein the polymer material is polyimide or parylene.

5. The flow cell of claim 1, wherein the electrodes are thin film electrodes formed from a material selected from the group consisting of a metal, carbon, graphite, pyrolyzed carbon or a combination thereof.

6. The flow cell of claim 5, wherein the metal is selected from the group consisting of Ti, Au, Pt, Pd, Cr, Cu, Ag or a combination thereof.

7. The flow cell of claim 1, wherein the inlet and the outlet of the microchannel are independently formed in either the substrate or the channel wall.

8. The flow cell of claim 1, wherein the plurality of electrodes further includes at least one reference electrode.

9. The flow cell of claim 1, further comprising at least one electrical source, each coupled to at least one of the working electrodes and one of the counter electrodes.

10. The flow cell of claim 1, wherein the volume of microchannel is from about 1 nL to about 200 nL.

11. The flow cell of claim 1, wherein the height of the microchannel is from about 0.1 microns to about 100 microns

12. The flow cell of claim 1, wherein the length of the microchannel is at least 10 times greater than the height of the microchannel.

13. The flow cell of claim 1, wherein the working electrodes and the counter electrodes are interdigitated.

14. The flow cell of claim 13. wherein a width of each of the working electrodes and each of the counter electrodes is from about 10 nm to about 100 microns.

15. The flow cell of claim 1, wherein each of the plurality of the electrodes extends through a full width of the microchannel.

16. The flow cell of claim 15, wherein the width of the microchannel is at least 10 times greater than the height of the microchannel.

17. The flow cell of claim 1, wherein the efficiency of the cell is at least 50%.

18. The flow cell of claim 17, wherein the efficiency of the cell is at least 90%.

19. The flow cell of claim 1, wherein the one or more working electrodes further comprise conductive particles packed inside the microchannel.

20. The flow cell of claim 19 wherein said conductive particles are made from a material selected from the group consisting of metal particles, porous graphite, porous carbon or a combination thereof.

21. The flow cell of claim 1, comprising a plurality of electrochemical cells in series, wherein each of the electrochemical cells is formed by at least one of the working electrodes and at least one of the counter electrodes.

22. The flow cell of claim 1, wherein the flow cell further comprises a resistive temperature detector (RTD) disposed within the microchannel on the substrate.

23. The flow cell of claim 16, wherein the RTD is a thin film metal resistor.

24. A microfluidic device comprising
an electrochemical flow cell as described in claim 1, having integrated therewith an electrospray ionization (ESI) nozzle formed on said substrate and in microfluidically coupled to at least one outlet of said electrochemical flow cell.

25. The microfluidic device of claim 24, further comprising a chromatography column microfluidically coupled to at least one inlet of the electrochemical flow cell.

26. The microfluidic device of claim 25, wherein said column is integrated with the electrochemical flow cell on the substrate.

27. The microfluidic device of claim 24, further comprising a plurality of electrochemical flow cells, wherein the electrospray ionization (ESI) nozzle is microfluidically coupled to at least one of the electrochemical flow cells.

28. The microfluidic device of claim 27, wherein at least one of the electrochemical flow cells is placed in series with the ESI nozzle,

29. The microfluidic device of claim 27, wherein at least one of the electrochemical flow cells is placed in parallel with the ESI nozzle.

30. The microfluidic device of claim 29, further comprising a flow splitter, wherein said flow splitter splits a flow of a fluid between the electrochemical flow cell in parallel with the ESI nozzle and the ESI nozzle directly.

31. The microfluidic device of claim 30, wherein the fluid is an eluent from a liquid chromatography process.

32. A method of making a microfluidic device integrating an electrochemical flow cell:
providing a substrate having a front surface and a back surface;
patterning a plurality of electrodes on the front surface;
depositing and patterning a first polymer layer on the front surface of the substrate to define a floor of the nozzle;
depositing and patterning a sacrificial photoresist layer over the front surface of the substrate, the plurality of the electrodes and the first polymer layer to define a microchannel region;
depositing and patterning a second polymer layer over the sacrificial photoresist layer to define a channel wall;
releasing the sacrificial photoresist to define a microchannel.

33. The method of claim 32, wherein the substrate is a silicon substrate.

34. The method of claim 32, wherein the electrodes are thin film electrodes formed from a material selected from the group consisting of Ti, Au, Pt, Pd, Cr, Cu, Ag, thin film carbon, graphite; pyrolyzed carbon or a combination thereof

35. The method of claim 32, wherein said patterning a plurality of electrodes comprises using E-beam lithography.

36. The method of claim 32, further comprising etching the substrate to make ESI nozzle overhanging.

37. The method of claim 36, wherein said etching comprises one of either xeon difluoride or bromine trifluoride etching.

38. The method of claim 32, further comprising etching the substrate through the back surface to define an inlet of the microchannel.

39. The method of claim 38, wherein said etching comprises deep reactive ion etching.

40. The method of claim 32, wherein the polymer layers comprise parylene.

41. The method of claim 32, wherein a length of the microchannel is greater than a height of the microchannel.

42. The method of claim 32, further comprising microfabricating an electrospray ionization nozzle integrally on the substrate with the microchannel.
